(19) United States
(12) Patent Application Publication
(10) Pub. No.: US 2017/0184043 A1
(43) Pub. Date: Jun. 29, 2017

(54) SYSTEM AND METHOD TO VERIFY INSTALLATION OF ASYMMETRIC PISTON

(71) Applicant: General Electric Company, Schenectady, NY (US)

(72) Inventors: Kenneth Edward Neuman, Waukesha, WI (US); Richard John Donahue, West Bend, WI (US); Jeffrey Jacob Bizub, Waukesha, WI (US)

(21) Appl. No.: 14/982,710

(22) Filed: Dec. 29, 2015

(51) Int. Cl. F02D 41/22; F02D 41/04; F02D 41/26; F02D 41/24; G05B 15/02; F02D 35/02

(52) U.S. Cl. CPC F02D 41/22; G05B 15/02; F02D 35/027; F02D 41/26; F02D 41/2406; F02D 41/042

(57) ABSTRACT

In one embodiment, a method may include retrieving, via a processor, a fundamental frequency of a cylinder type from a memory communicatively coupled to the processor, receiving, via the processor, a first signal from a first knock sensor disposed on a cylinder. The cylinder is disposed in an engine. The method may also include deriving whether a number of amplitudes of the first signal at the fundamental frequency and one or more harmonic frequencies exceed an undesired installation threshold value, and identifying an asymmetric piston as having an undesired installation if the undesired installation threshold value exceeds the number of amplitudes of the first signal and the one or more harmonic frequencies.

### BACKGROUND OF THE INVENTION

The subject matter disclosed herein relates to reciprocating engines. More particularly, the subject matter disclosed herein relates to verifying installation of asymmetric pistons in reciprocating engines.

Asymmetric pistons (e.g., pistons with asymmetric profiles) may be used in reciprocating engines to account for various properties (e.g., thermal distortion) and/or operational characteristics (e.g., secondary motion). Additionally, the asymmetric pistons may provide one or more performance benefits to the reciprocating engine. For example, some asymmetric pistons may include less materials and therefore weigh less than symmetric pistons, thereby enabling faster movement. However, the asymmetry of the pistons may mean that the pistons function as intended in only one installed orientation. If installed in the incorrect orientation, the asymmetric piston may have unintended contact with the cylinder, which may result in wear, loss of performance, or failure. As such, enhanced measures to identify incorrectly installed asymmetric pistons are desired.

### BRIEF DESCRIPTION OF THE INVENTION

Certain embodiments commensurate in scope with the present disclosure are summarized below. These embodiments are not intended to limit the scope of the claimed disclosure, but rather these embodiments are intended only to provide a brief summary of possible forms of the disclosure. Indeed, the disclosure may encompass a variety of forms that may be similar to or different from the embodiments set forth below.

In one embodiment, a method may include retrieving, via a processor, a fundamental frequency of a cylinder type from a memory communicatively coupled to the processor, receiving, via the processor, a first signal from a first knock sensor disposed on a cylinder. The cylinder is disposed in an engine. The method may also include deriving whether a number of amplitudes of the first signal at the fundamental frequency and one or more harmonic frequencies exceed an undesired installation threshold value, and identifying an asymmetric piston as having an undesired installation if the undesired installation threshold value exceeds the number of amplitudes of the first signal and the one or more harmonic frequencies.

In one embodiment, a system may include an engine control unit (ECU) configured to control operations of an engine. The ECU may include a processor configured to perform the steps of retrieve a fundamental frequency of a cylinder type, receive a first signal from a first knock sensor disposed on a cylinder (the cylinder is disposed in the engine), derive whether a number of amplitudes of the first signal at the fundamental frequency and one or more harmonic frequencies exceed an undesired installation threshold value, and identify an asymmetric piston as having an undesired installation if the undesired installation threshold value exceeds the number of amplitudes of the first signal and the one or more harmonic frequencies.

In one embodiment, a non-transitory computer readable medium may include executable instructions that, when executed by a processor, cause the processor to retrieve a fundamental frequency of a cylinder type, receive a first signal from a knock sensor disposed on a cylinder (the cylinder is disposed in an engine), derive whether a number of amplitudes of the first signal at the fundamental frequency and one or more harmonic frequencies exceed an undesired installation threshold value, and identify an asymmetric piston as having an undesired installation if the undesired installation threshold value exceeds the number of amplitudes of the first signal and the one or more harmonic frequencies.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of an engine driven power generation system in accordance with aspects of the present disclosure;

FIG. 2 is a side cross-sectional view of an embodiment of a correctly installed asymmetric piston assembly in accordance with aspects of the present disclosure;

FIG. 3 is a side cross-sectional view of an embodiment of an asymmetric piston assembly that may include an undesired installation in accordance with aspects of the present disclosure;

FIG. 4 is an embodiment of a sample spectrum plot of data captured by a knock sensor in accordance with aspects of the present disclosure;

FIG. 5 is a flow chart showing an embodiment of a process for detecting when a piston is installed incorrectly using a knock sensor in accordance with aspects of the present disclosure; and

FIG. 6 is a top view of an embodiment of an asymmetric piston including radial profile asymmetry;

FIG. 7 is a side view of an embodiment of an asymmetric piston including an asymmetric top land and an asymmetric skirt in accordance with aspects of the present disclosure;

FIG. 8 is a top view of an embodiment of an asymmetric piston including an asymmetric bowl in accordance with aspects of the present disclosure; and

FIG. 9 is a side view of an embodiment of an asymmetric piston including center of gravity offset, pin offset, and an asymmetric undercrown in accordance with aspects of the present disclosure.

### DETAILED DESCRIPTION OF THE INVENTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As briefly mentioned above, certain engines, such as reciprocating engines, may use pistons with asymmetric features to enhance performance, efficiency, durability, emissions, and reliability, among other things. For example, pistons may be designed with asymmetric profiles on a skirt and/or top land to reduce friction, hydrocarbon emissions, wear, and the like and/or to enhance deposit control, robustness, and the like. Improper installation of the asymmetric pistons may cause the piston to have unintended contact with the cylinder and cause wear, loss of performance, and/or engine failure. The contact between the asymmetric piston and the cylinder may also result in a different acoustic signature than when the asymmetric piston is properly installed and moving through a cylinder.

Accordingly, some embodiments of the present disclosure relate to determining when an asymmetric piston is improperly installed based at least on acoustic signatures. As such, in some embodiments, engine knock sensors may be used to detect the acoustic signatures emitted by the asymmetric pistons moving through the cylinders. Signal processing may be used by an engine control unit (ECU) to determine whether the acoustic signature detected indicates an incorrectly installed asymmetric piston. In some embodiments, the testing of the signals may be performed during a start-up routine when the engine is in a reduced operating state, during normal operation of the engine, or both. When the ECU determines that the acoustic signature indicates improper installation, then the ECU may perform one or more preventative actions, such as shutting down the engine, alerting a user, or the like.

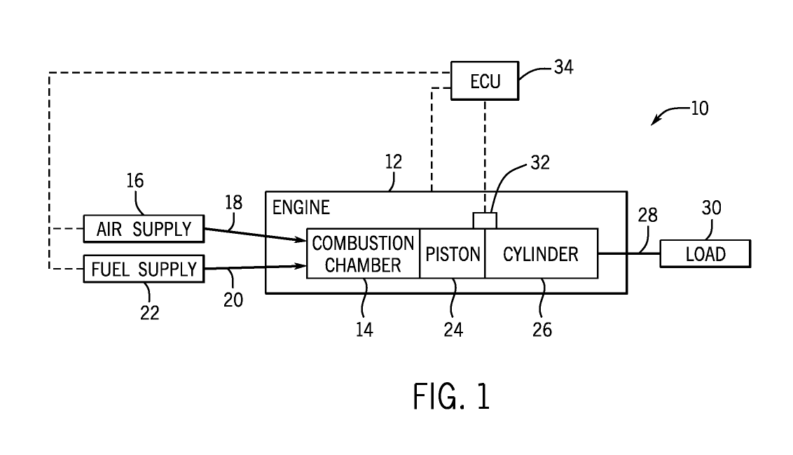

Turning to the drawings, FIG. 1 illustrates a block diagram of an embodiment of a portion of an engine driven power generation system 10. As described in detail below, the system 10 includes an engine 12 (e.g., a reciprocating internal combustion engine) having one or more combustion chambers 14 (e.g., 1, 2, 3, 4, 5, 6, 7, 8, 10, 12, 14, 16, 18, 20, or more combustion chambers 14). Though FIG. 1 shows a combustion engine 12, it should be understood that any reciprocating device may be used. An air supply 16 is configured to provide a pressurized oxidant 18, such as air, oxygen, oxygen-enriched air, oxygen-reduced air, or any combination thereof, to each combustion chamber 14. The combustion chamber 14 is also configured to receive a fuel 20 (e.g., a liquid and/or gaseous fuel) from a fuel supply 22, and a fuel-air mixture ignites and combusts within each combustion chamber 14. The hot pressurized combustion gases cause a piston 24 adjacent to each combustion chamber 14 to move linearly within a cylinder 26 and convert pressure exerted by the gases into a rotating motion, which causes a shaft 28 to rotate. The pistons 24 may include asymmetric features that enable certain benefits discussed above. It should be noted that the pistons having asymmetric features are referred to as “asymmetric pistons 24” herein. Further, the shaft 28 may be coupled to a load 30, which is powered via rotation of the shaft 28. For example, the load 30 may be any suitable device that may generates power via the rotational output of the system 10, such as an electrical generator. Additionally, although the following discussion refers to air as the oxidant 18, any suitable oxidant may be used with the disclosed embodiments. Similarly, the fuel 20 may be any suitable gaseous fuel, such as natural gas, associated petroleum gas, propane, biogas, sewage gas, landfill gas, coal mine gas, for example.

The system 10 disclosed herein may be adapted for use in stationary applications (e.g., in industrial power generating engines) or in mobile applications (e.g., in cars or aircraft). The engine 12 may be a two-stroke engine, three-stroke engine, four-stroke engine, five-stroke engine, or six-stroke engine. The engine 12 may also include any number of combustion chambers 14, asymmetric pistons 24, and associated cylinders (e.g., 1-24). For example, in certain embodiments, the system 10 may include a large-scale industrial reciprocating engine having 4, 6, 8, 10, 16, 24 or more asymmetric pistons 24 reciprocating in cylinders 26. In some such cases, the cylinders and/or the asymmetric pistons 24 may have a diameter of between approximately 13.5-34 centimeters (cm). In some embodiments, the cylinders and/or the asymmetric pistons 24 may have a diameter of between approximately 10-40 cm, 15-25 cm, or about 15 cm. The system 10 may generate power ranging from 10 kW to 10 MW. In addition, the asymmetric pistons 24 may include various asymmetries, such as profile or shape differences between the sides of the piston 24, feature offsets from the vertical pin axis plane of the piston 24, top land axis offset, skirt profile asymmetry, bowl asymmetries, pin offset, center-of-gravity offset, undercrown asymmetries, or some combination thereof.

In some embodiments, the engine 12 may operate at less than approximately 1800 revolutions per minute (RPM). In some embodiments, the engine 12 may operate at less than approximately 2000 RPM, 1900 RPM, 1700 RPM, 1600 RPM, 1500 RPM, 1400 RPM, 1300 RPM, 1200 RPM, 1000 RPM, 900 RPM, or 750 RPM. In some embodiments, the engine 12 may operate between approximately 750-2000 RPM, 900-1800 RPM, or 1000-1600 RPM. In some embodiments, the engine 12 may operate at approximately 1800 RPM, 1500 RPM, 1200 RPM, 1000 RPM, or 900 RPM. Exemplary engines 12 may include General Electric Company's Jenbacher Engines (e.g., Jenbacher Type 2, Type 3, Type 4, Type 6 or J920 FleXtra) or Waukesha Engines (e.g., Waukesha VGF, VHP, APG, 275GL), for example.

The driven power generation system 10 may include one or more knock sensors 32 suitable for detecting engine “knock” and/or other run characteristics of the engine 12. The knock sensor 32 may be any sensor configured to sense vibrations caused by the engine 12, such as vibration due to detonation, pre-ignition, and or pinging. The knock sensor 32 is shown communicatively coupled to a controller, engine control unit (ECU) 34. During operations, signals from the knock sensors 32 are communicated to the ECU 34 to determine if knocking conditions (e.g., pinging), or other behaviors exist. The ECU 34 may then adjust certain engine 12 parameters to ameliorate or avoid the undesirable conditions. For example, the ECU 34 may adjust ignition timing and/or adjust boost pressure to avoid knocking. As further described herein, the knock sensors 32 may additionally detect other vibrations beyond knocking, for example, acoustic signatures indicative of incorrectly installed asymmetric pistons 24.

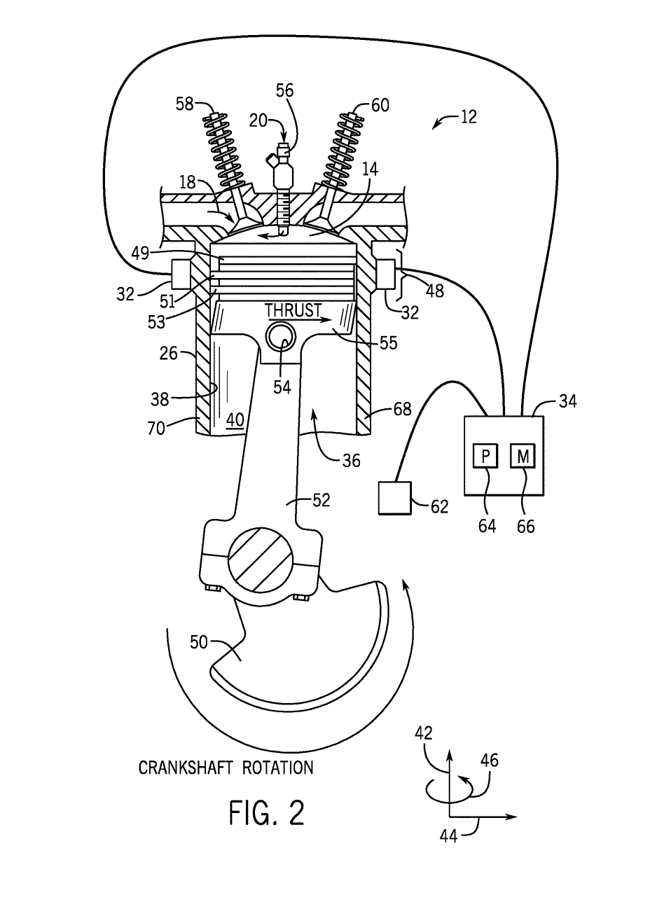

FIG. 2 is a side cross-sectional view of an embodiment of an asymmetric piston assembly 36 having an asymmetric piston 24 correctly installed within a cylinder 26 (e.g., an engine cylinder) of the reciprocating engine 12. The cylinder 26 has an inner annular wall 38 defining a cylindrical cavity 40 (e.g., bore). The asymmetric piston 24 may be defined by an axial axis or direction 42, a radial axis or direction 44, and a circumferential axis or direction 46. The asymmetric piston 24 includes a top portion 48 (e.g., a crown). The top portion 48 generally blocks the fuel 20 and the air 18, or a fuel-air mixture, from escaping from the combustion chamber 14 during reciprocating motion of the piston 24. In the depicted embodiment, the top portion 48 is asymmetrical due to a top land 49, a second land 51, and a third land 53 having offset axes. The asymmetric piston 24 also includes a bottom portion 55 (e.g., skirt). As depicted, the skirt 55 includes an asymmetrical axial profile due to different taper angles in the thrust and anti-thrust directions. As described further below, in addition to changes to the profile of the top portion 48 and/or the bottom portion 55 there may be numerous other features that provide an asymmetry to the piston 24. For example, various types of asymmetries may include the shape of a bowl may be asymmetric, a pin may be offset, the center of gravity may be offset in the piston and/or in the connecting rod, the overall structure may be asymmetric due to material selection and/or undercrown shape, and so forth. As previously mentioned, the asymmetries inherent in the piston 24 may enhance performance of the engine 12. However, due to the asymmetric nature of the piston 24, the asymmetric piston 24 may only be properly installed in one orientation. If the asymmetric piston 24 is installed incorrectly, robustness and reliability of the engine 12 may suffer. Thus, as described in detail below, the presently disclosed techniques enable detecting desired and undesired installations of the asymmetric piston 24 based at least on acoustic signatures.

As shown, the asymmetric piston 24 is attached to a crankshaft 50 via a connecting rod 52 and a pin 54. The crankshaft 50 translates the reciprocating linear motion of the asymmetric piston 24 into a rotating motion. As the asymmetric piston 24 moves, the crankshaft 50 rotates to power the load 30 (shown in FIG. 1), as discussed above. As shown, the combustion chamber 14 is positioned adjacent to the top portion 48 of the asymmetric piston 24. A fuel injector 56 provides the fuel 20 to the combustion chamber 14, and an intake valve 58 controls the delivery of air 18 to the combustion chamber 14. An exhaust valve 60 controls discharge of exhaust from the engine 12. However, it should be understood that any suitable elements and/or techniques for providing fuel 20 and air 18 to the combustion chamber 14 and/or for discharging exhaust may be utilized, and in some embodiments, no fuel injection is used. In operation, combustion of the fuel 20 with the air 18 in the combustion chamber 14 cause the asymmetric piston 24 to move in a reciprocating manner (e.g., back and forth) in the axial direction 42 within the cavity 40 of the cylinder 26. A properly installed asymmetric piston 24 may cause mechanical vibrations at frequencies with certain amplitudes in the cylinder 26 while operating, and an improperly installed asymmetric piston 24 may cause the frequencies to have different amplitudes in the cylinder 26 while operating. In some embodiments, the ECU 34 may baseline the fundamental frequency of vibration for a properly installed asymmetric piston 24 and sample data at certain times (e.g., such as when the engine 12 is first assembled, started, reassembled, or restarted) to determine whether the frequency of vibration caused by the asymmetric piston 24 in the cylinder 26 differs from the baseline, as described in detail below.

During operations, when the asymmetric piston 24 is at the highest point in the cylinder 26 it is in a position called top dead center (TDC). When the asymmetric piston 24 is at its lowest point in the cylinder 26, it is in a position called bottom dead center (BDC). As the asymmetric piston 24 moves from top to bottom or from bottom to top, the crankshaft 50 rotates one half of a revolution. Each movement of the piston 24 from top to bottom or from bottom to top is called a stroke, and engine 12 embodiments may include two-stroke engines, three-stroke engines, four-stroke engines, five-stroke engine, six-stroke engines, or more.

During engine 12 operations, in the four-stroke embodiment, a sequence including an intake process, a compression process, a power process, and an exhaust process typically occurs. The intake process enables a combustible mixture, such as fuel and air, to be pulled into the cylinder 26, thus the intake valve 58 is open and the exhaust valve 60 is closed. The compression process compresses the combustible mixture into a smaller space, so both the intake valve 58 and the exhaust valve 60 are closed. The power process ignites the compressed fuel-air mixture, which may include a spark ignition through a spark plug system, and/or a compression ignition through compression heat. The resulting pressure from combustion then forces the piston 24 to BDC. The exhaust process typically returns the piston 24 to TDC while keeping the exhaust valve 60 open. The exhaust process thus expels the spent fuel-air mixture through the exhaust valve 60. It is to be noted that more than one intake valve 58 and exhaust valve 60 may be used per cylinder 26.

The engine 12 may also include a crankshaft sensor 62, one or more knock sensors 32, and the engine control unit (ECU) 34, which includes a processor 64 and memory 66 (e.g., non-transitory computer readable medium). The crankshaft sensor 62 senses the position and/or rotational speed of the crankshaft 50. Accordingly, a crank angle or crank timing information may be derived. That is, when monitoring combustion engines, timing is frequently expressed in terms of crankshaft 50 angle. For example, a full cycle of a four stroke engine 12 may be measured as a 720° cycle. The one or more knock sensors 32 may be a Piezo-electric accelerometer, a microelectromechanical system (MEMS) sensor, a Hall effect sensor, a magnetostrictive sensor, and/or any other sensor designed to sense vibration, acceleration, sound, and/or movement. In other embodiments, sensor 32 may not be a knock sensor in the traditional sense, but any sensor that may sense vibration, pressure, acceleration, deflection, or movement.

Because of the percussive nature of the engine 12, the knock sensor 32 may be capable of detecting signatures even when mounted on the exterior of the cylinder 26. The one or more knock sensors 32 may be disposed at many different locations on the engine 12. For example, in FIG. 2, two knock sensors 32 are shown, one on either side of the cylinder 26. In other embodiments, only one knock sensor 32 may be used on the side of the cylinder 26. In order to best detect incorrectly installed asymmetric pistons 24 that result in contact between the asymmetric pistons 24 and the cylinders 26, the knock sensor 32 may be disposed on the thrust side of the cylinder 26 and oriented perpendicular to piston travel. In still other embodiments, the knock sensor 32 may be disposed on the head of the cylinder 26. Additionally, in some embodiments, a single knock sensor 32 may be shared, for example, with one or more adjacent cylinders 26. In other embodiments, each cylinder 26 may include one or more knock sensors 32 on either or both sides of a cylinder 26. The crankshaft sensor 62 and the knock sensor 32 are shown in electronic communication with the engine control unit (ECU) 34. The ECU 34 includes a processor 64 and a memory 66. The memory 66 may store non-transitory code or computer instructions that may be executed by the processor 64 to perform the techniques disclosed herein. In some embodiments, the memory may store a fundamental frequency of a cylinder type. The cylinder type may include information related to whether the cylinder is asymmetric or symmetric. If the cylinder is asymmetric, the cylinder type may also include information related to the kinds of asymmetries of the cylinder (e.g., offset pin, offset axes, shape, structure). The ECU 34 monitors and controls and operation of the engine 12, for example, by adjusting spark timing, valve 58, 60 timing, adjusting the delivery of fuel and oxidant (e.g., air), and so on.

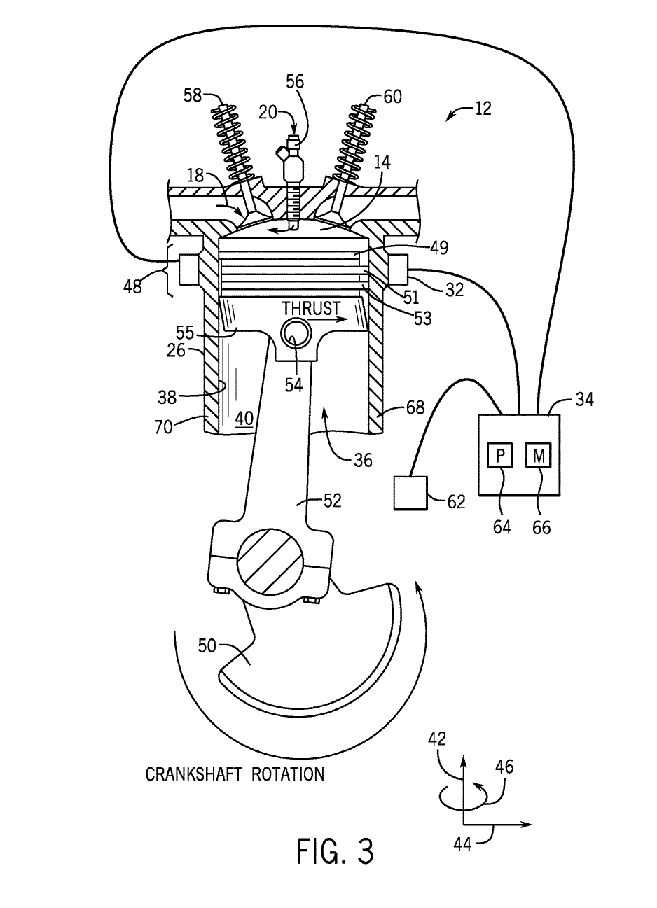

FIG. 3 is a side cross-sectional view of an embodiment of an incorrectly installed asymmetric piston assembly 36. As mentioned above, an incorrectly installed asymmetric piston 24 may be detected based on acoustic signatures, and one or more preventative actions may be performed. Asymmetric pistons 24 are designed with certain asymmetries to provide performance benefits; however, oftentimes, the asymmetries are present in the outer profiles of the piston 24, and the outer profiles may interact with the structure of the inner annular wall 38 of the cylinder 26. Further, the asymmetries may handle loading in particular ways by design when the center of gravity is intentionally shifted, pins are offset, and the like. When installed correctly, the inherent features of the asymmetric pistons 24 generate vibrations of a particular fundamental frequency and harmonic frequencies with certain amplitudes during operation. In contrast, when installed incorrectly, the asymmetric pistons 24 may generate vibrations of a different frequency with difference amplitudes at the fundamental frequency and the harmonic frequencies due to the outer profile of the top portion 48 and/or bottom portion 55 rubbing the inner annular wall 38 in different ways, and/or the load being applied differently to the asymmetric piston 24, thereby causing it to contact the inner annular wall 38 undesirably.

As shown in FIG. 3, the asymmetric piston 24 is installed in a reversed orientation as opposed to its installation depicted in FIG. 2. As depicted in the incorrect installation in FIG. 3, the bottom right corner of the skirt 55 is contacting the inner annular wall 38 on a thrust side 68 and the top left corner of the skirt 55 is contacting the inner annular wall 38 on an anti-thrust side 70, which is an opposite structural interaction than the correct installation depicted in FIG. 2. Further, as depicted in FIG. 3 the top land 49 is contacting the inner annular wall 38 on the anti-thrust side 70 and the second land 51 and the third land 53 are contacting the inner annular wall 38 on the thrust side 68, which is an opposite structural interaction than the correct installation depicted in FIG. 2. As may be appreciated, during operation, the incorrectly installed asymmetric piston 24 may generate a frequency of vibration different than a correctly installed asymmetric piston 24. The ECU 34 may detect the difference in frequencies and, depending on the severity of the difference, the ECU 34 may perform an appropriate preventative action.

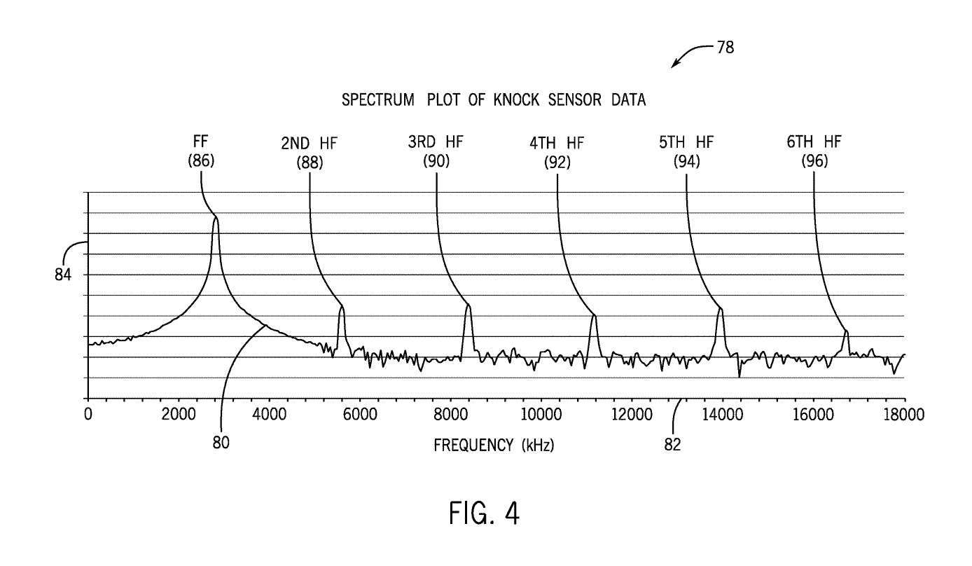

An embodiment of a sample spectrum plot 78 of data 80 captured by a knock sensor 32 disposed on the side of the cylinder 26 is shown in FIG. 4. The horizontal axis 82 of the spectrum plot is frequency (in kHz), and the vertical axis 84 represents amplitude. Because an incorrectly installed asymmetric piston 24 may rub against the side of the cylinder 26, the rubbing excites the cylinder 26, causing it to resonate at its fundamental frequency and the various harmonics of that fundamental frequency.

The fundamental frequency of a cylinder in a combustion engine can be found by using Draper's equation, or experimentally through frequency analysis. Draper's equation is as follows:

$${f}_{m , n} = \frac{{c}_{0} \sqrt{T} {n}_{m , n}}{π B} , \qquad Equation ( 1 )$$

where f_{m,n} is the resonant frequency of the cylinder, n_{m,n} the non-dimensional mode number, co is the phase velocity constant, T is temperature of the combustion mixture, B is the cylinder bore diameter, and m,n are the radial and circumferential mode numbers. Once determined, the fundamental frequency of the cylinder 26 may be provided as input to the ECU 34 or predetermined and stored on the memory 66 to be obtained and/or processed by the processor 64.

Line 86 represents the fundamental frequency of the cylinder 26, in this particular embodiment approximately 2783 Hz. It should be understood that this is merely an example and that the fundamental frequency 86 may change from cylinder 26 to cylinder. Harmonics occur at multiple whole integers of the fundamental frequency 86. For example, in this embodiment, the second harmonic frequency 88 occurs at about 5566 Hz, or twice the fundamental frequency. Similarly, the third harmonic frequency 90 occurs at about 8350 Hz, the fourth harmonic frequency 92 at about 11133 Hz, the fifth harmonic frequency 94 at about 13916 Hz, the sixth harmonic frequency 96 at about 16699 Hz, and so on. Again, these values are merely an example and specific to the cylinder 26 of the present embodiment. The fundamental frequency 86 and the various harmonics 88, 90, 92, 94, and 96 will vary depending upon the cylinder 26. The memory 66 may store an incorrectly installed asymmetric piston 24 frequency threshold value, which may be in the form of a raw amplitude value, a percentage increase, or some other value. When the amplitude at a frequency exceeds the threshold value, an incorrectly installed asymmetric piston 24 may be determined to be present.

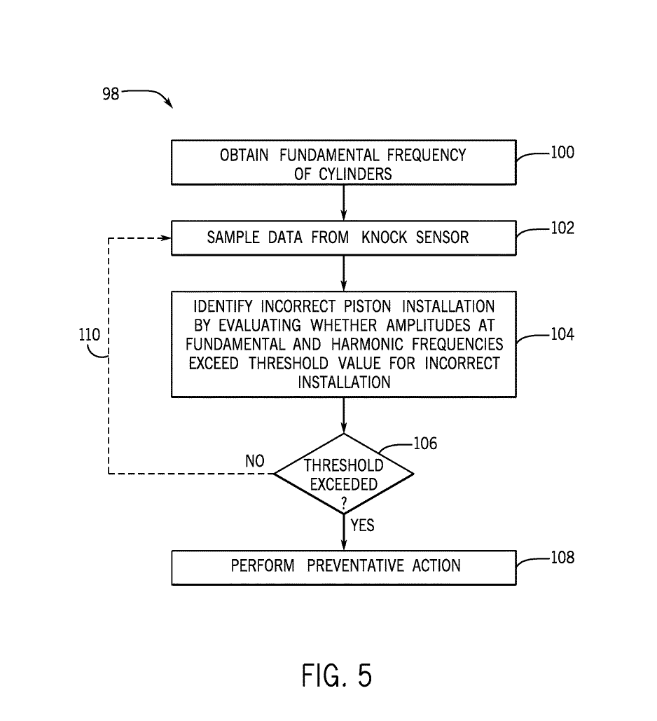

FIG. 5 is a flow chart showing an embodiment of a process 98 for detecting incorrectly installed asymmetric pistons 24 using at least a knock sensor 32. The process 98 may be implemented as computer instructions or executable code stored in the memory 66 and executable by the processor 64 of the ECU 34. In block 100, the process 98 retrieves (e.g., receives, from a user or another device, accesses from memory 66, or some other method) the fundamental frequency of the cylinder 26 type (e.g., asymmetric cylinder and/or kinds of asymmetries of the cylinder 26). The fundamental frequency may be referred to as a baseline frequency for a correctly installed asymmetric piston 24. In some embodiments, the baseline frequency may be obtained by correctly installing the asymmetric pistons 24 in a test environment, starting the engine 12, and obtaining and storing the baseline frequency (e.g., fundamental frequency) of the cylinder 26 type resulting from motion of the correctly installed asymmetric piston 24. In some embodiments, the fundamental frequency may be referred to as a baseline frequency for an incorrectly installed asymmetric piston 24 and the baseline frequency may be obtained by incorrectly installing the asymmetric piston 24 in a test environment, starting the engine 12, and obtaining and storing the baseline frequency (e.g., fundamental frequency) of the cylinder 26 type resulting from motion of the incorrectly installed asymmetric piston 24.

In block 102, a sample of data is sampled using the knock sensor 32. For example, the one or more knock sensors 32 collect data and then transmit the data to the ECU 34. In the present embodiment, a single knock sensor 32 is mounted on the thrust side 68 of the cylinder 26 and oriented perpendicular to the direction of asymmetric piston 24 travel. In some embodiments, the data is sampled during a combustion cycle of the engine 12. In some embodiments, the data is sampled while simply turning the engine 12 without combustion, for example by using a test mode. In such embodiments, there may be a minimum speed that is attained before sampling occurs. That is, the process 98 may take a certain amount of time to accumulate and process the vibration signals according to the techniques described herein.

In block 104, the process 98 identifies incorrect asymmetric piston 24 installation by evaluating whether amplitudes at the fundamental frequency 86 (e.g., baseline frequency) of the cylinder 26 and the harmonic frequencies of the fundamental frequency 86 of the cylinder 26 exceed a threshold value for undesired installation. This may involve referencing a look up table including amplitudes for correctly installed asymmetric pistons 24 stored on the memory 66 and comparing the amplitude within one or more windows of frequencies to the look up table. The threshold value may include a percentage (e.g., 1, 2, 3, 4, 8, 12, 16, 32, 64 percent) of amplitude increase or decrease or a range of amplitudes. Block 104 may also involve determining whether the amplitude exceeds the baseline frequency of vibration for a desiredly installed asymmetric piston 24 stored in the memory 66.

Block 104 may also involve applying one or more filters to the signal. Filters used by the process 98 may include low pass filters, high pass filters, band pass filters, and the like. The harmonic frequencies of the cylinder 26 may be multiples of the fundamental frequency 86 of the cylinder 26. For example, the second harmonic frequency 88 is twice the fundamental frequency 86 of the cylinder 26. In block 104, the process 98 may analyze or evaluate the fundamental frequency 86, as well as the second harmonic 88, third harmonic 90, fourth harmonic 92, fifth harmonic 94, sixth harmonic 96, and so on. The process 98 may analyze or evaluate a range of frequencies surrounding the frequency in question. For example, the process 98 may analyze or evaluate frequencies in the range of ±0.5%, ±1%, ±2%, or ±5% of the frequency in question. Block 104 may include comparing the amplitudes at the frequencies to a look up table or a baseline frequency of vibration for a correctly installed asymmetric piston 24 threshold value stored in memory 66. In some embodiments, block 104 may include comparing the amplitudes at the frequencies to a look up table or a baseline frequency of vibration for an incorrectly installed asymmetric piston 24 threshold value stored in memory 66.

Further, in some embodiments, the signals of incorrectly installed asymmetric pistons 24 may be characterized. For example, tests may be run where the asymmetric pistons 24 are installed in different incorrect orientations, the engine 12 may be started, and the vibration signals of the cylinder 26 may be obtained. The obtained vibration signals may be associated with the type of asymmetric piston 24 and the incorrect installation orientation and stored in the memory 66. Thus, in some embodiments, block 104 may include identifying the type of asymmetric piston 24 and the actual incorrect installation orientation based on similarly obtained vibration signals.

Additionally, in some embodiments, in situ training may be locally performed on the cylinders 26 of the engine by the ECU 34. That is, the ECU 34 may analyze vibration signals from all of the cylinders 26 and run a learning genetic algorithm (e.g., neural network) to determine a baseline frequency of vibration for correctly installed asymmetric pistons 24. In some embodiments, the genetic algorithm may sample from the vibration signals of the various cylinders 26 and estimate a normalizing constant by approximating target probability distributions to determine the baseline frequency of vibration. In some embodiments, the ECU 34 may determine the most common frequency of vibration between the cylinders 26 as the baseline. The ECU 34 may identify that the vibration signals for one of the cylinders 26 differs from the determined baseline frequency 26 for correctly installed asymmetric pistons 24. As a result, the processor 64 may identify the deviation as a result of an incorrectly installed asymmetric piston 24 in block 104.

In decision 106, the process 98 compares the amplitudes at the given frequencies to one or more threshold values store in memory 66 or to a look up table. If the process 98 determines that an incorrectly installed asymmetric piston 24 is present (e.g., the amplitude exceeds the threshold or baseline), the process 98 moves to block 108 and performs one or more preventative actions. The preventative action may include alerting the user that the asymmetric piston 24 is installed incorrectly, sounding an alarm, putting the engine 12 into a certain mode of operation (e.g., run low load, low power, and/or low speed to put the engine 12 into a low idle condition), shutting down the engine 12 (e.g., hard shutdown, cut fuel). The user may be alerted in a number of different ways, including proprietary or standard error codes (e.g. sent via CAN or OBDII interfaces), via a display, sounds or audio notifications, on a display, via text, and the like. In some embodiments, the preventative action that is performed may be selected based on the severity of the amplitudes or how severely the amplitudes exceed the threshold or baseline. For example, if the amplitude exceeds the threshold or baseline by a relatively minimal amount, the ECU 34 may determine that the engine 12 will not be significantly affected and run the engine 12 in a low power mode until a certain objective is complete and then shut down the engine so the asymmetric piston 24 can be reinstalled. Likewise, the ECU 34 may send or display an alert to the user to reinstall the asymmetric piston 24. On the other hand, if the ECU 34 determines that the amplitudes exceed the threshold or baseline for a correctly installed asymmetric piston 24 by a relatively high amount or percentage, then the ECU 34 may shut down the engine 12.

If the process 98 determines that an incorrectly installed asymmetric piston 24 is not present (e.g., the amplitude does not exceed the threshold or baseline), the process 98 may move to block 102, as shown by optional dotted arrow 110, and samples more data from the knock sensors. The process 98 may be run as often or as little as desired. For example, because the frequency of vibration of an incorrectly installed asymmetric piston 24 may be detected relatively quickly when the engine 12 is first started, the process 98 may be executed by the ECU 34 as a start-up routine (e.g., after the engine 12 is rebuilt, when the engine is first built 12, every time the engine 12 is started). In some embodiments, the start-up routine may be performed by running the engine 12 in a test mode with or without combustion, depending on the type of asymmetric feature of the piston 24. When an incorrectly installed asymmetric piston 24 is detected, the ECU 34 may perform the one or more preventative actions. When a correctly installed asymmetric piston 24 is detected, the ECU 34 may cause the engine 12 to exit the test mode. Further, the process 98 may be executed for a certain amount of time (e.g., after 1, 2, 3, 4, 5, 10 hours) and then stopped. In some embodiments, the process 98 is continuously executed by the processor 64 while the engine 12 is operational. In some embodiments, the process 98 is executed periodically over a certain period of time. For example, the process 98 may be performed every day for a certain amount of time. In some embodiments, the process 98 is run once when the engine 12 is first built and started or when the engine is 12 rebuilt and restarted. In some embodiments, the process 98 is executed based upon user request.

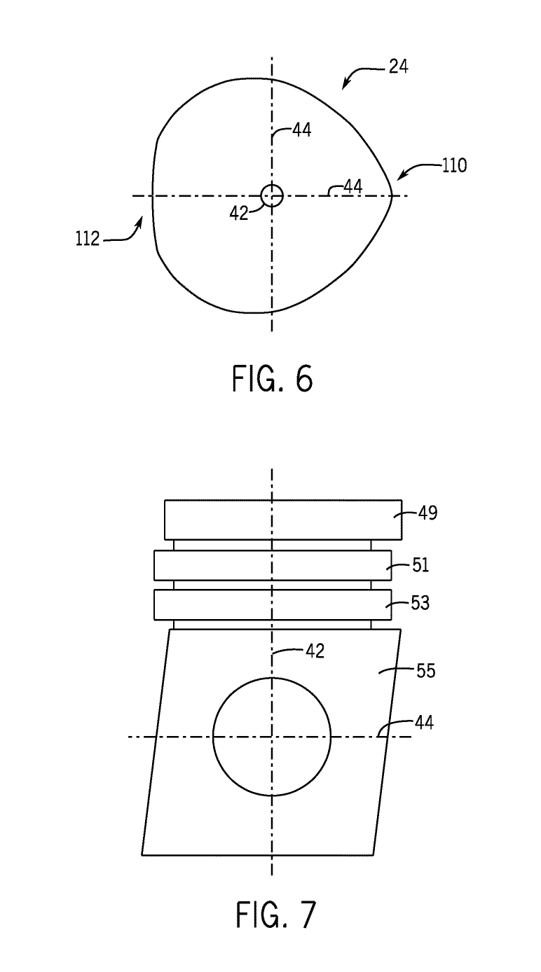

FIGS. 6-9 illustrate various different asymmetries that may be included in the piston 24. As previously mentioned, the asymmetric aspects of the piston 24 may allow the asymmetric piston 24 to only be installed in one correct orientation in the cylinder 26. When the asymmetric piston 24 is installed incorrectly, the engine 24 may suffer a loss of performance or other undesirable consequence. As such, the ECU 34 may use process 98 to detect when the asymmetric piston 24 is incorrectly installed based at least on vibration signals.

Starting with FIG. 6, a top view of an embodiment of an asymmetric piston 24 including radial 44 profile asymmetry. As depicted, one half of the piston 24 includes an ovular profile 110, whereas the other half of the piston 24 includes a circular/flat profile 112. Asymmetric pistons 24 including the radial profile asymmetry may only fit into a cylinder 26 tailored to the radial profile of the piston 24 in a particular way.

FIG. 7 is a side view of an embodiment of an asymmetric piston 24 including an asymmetric top land 49 and an asymmetric skirt 55. As depicted, the top land 49 is offset from axial axis 42, whereas the second land 51 and 53 are centered on the axial axis 42. In this way, the axial profile of the lands may be modified as desired for certain performance enhancements to create an asymmetric outer profile of the piston 24. If the asymmetric piston 24 is installed incorrectly, the different structural interactions of the lands 49, 51, and 53 with the cylinder 26 may be detectable using the techniques disclosed herein. Further, the radial profile of the lands 49, 51, and 53 may also be modified to provide an asymmetric profile to the piston 24. As depicted, the skirt 55 includes different taper angles on the thrust and anti-thrust sides that provides axial profile asymmetry to the piston 24. In addition to differing taper angles, axial asymmetry on the skirt may also include barrel shapes of differing curvature, differing barrel peak location, or other asymmetry. It should be understood that the radial profile of the skirt 55 may be modified to provide asymmetry to the piston 24. If the asymmetric piston 24 is installed incorrectly, the different structural interactions of the skirt 55 with the cylinder 26 may be detectable using the techniques disclosed herein.

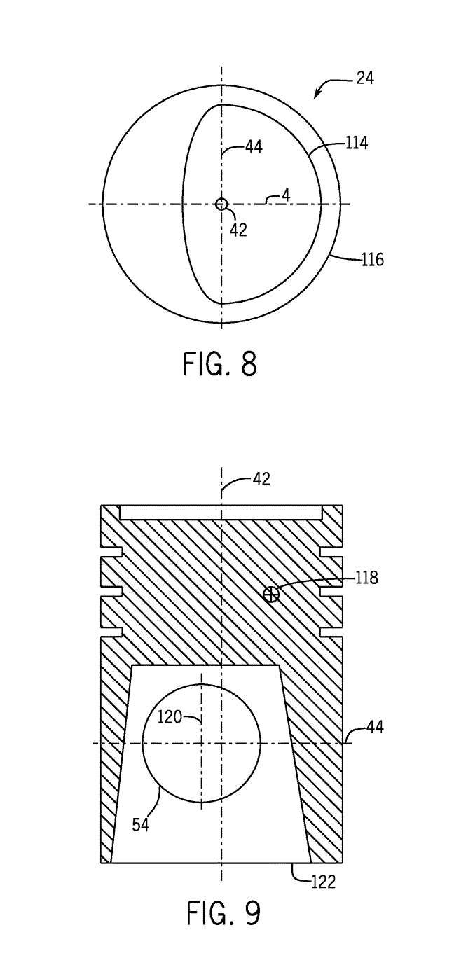

FIG. 8 is a top view of an embodiment of an asymmetric piston 24 including an asymmetric bowl 114. As depicted, the asymmetric bowl 114 is “carved” out of the interior of an outer wall 116 of the asymmetric piston 24. The asymmetry of the bowl 114 may cause the center of gravity of the asymmetric piston 24 to be offset, thereby changing the way the piston 24 interacts with and within the structure of the cylinder 26. This structural interaction may be detectable using the disclosed techniques if the piston 24 is installed incorrectly.

FIG. 9 is a side view of an embodiment of an asymmetric piston 24 including a center-of-gravity 118 offset from axial axis 42, the pin 54 with its axial axis 120 offset from axial axis 42 of the piston 24, and an asymmetric undercrown 122. Offsetting the center-of-gravity 118 of the piston, or of the connecting rod may alter the magnitude and distribution of forces between the piston 24 and cylinder 26, and the secondary motion of the piston 24 within the cylinder 26. Further, offsetting the pin 54 may alter the thrust forces and piston secondary motion. If installed incorrectly, the offset center of gravity may cause different vibration signals to be generated by the cylinder 26 than when the asymmetric piston 24 is installed correctly. Using the techniques described herein, the ECU 34 may detect the incorrect installation. As depicted, the undercrown 122 has a radially asymmetric profile because its base is wider than its top. Further, other asymmetries that may be included in the piston 24 may include the material selection of any of the components of the piston 24.

Technical effects of the invention include detecting when an asymmetric piston 24 is installed in an undesired manner using at least a knock sensor. For example, incorrectly installed asymmetric pistons 24 may cause different acoustic/vibration signatures that can be detected by the engine knock sensors. When an incorrectly installed asymmetric piston 24 is detected, the ECU 34 may perform one or more preventative actions. The preventative action(s) selected may depend on the severity of the signals detected.

This written description uses examples to disclose the techniques, including the best mode, and also to enable any person skilled in the art to practice the techniques, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method, comprising:
retrieving, via a processor, a fundamental frequency of a cylinder type from a memory communicatively coupled to the processor;
receiving, via the processor, a first signal from a first knock sensor disposed on a cylinder, wherein the cylinder is disposed in an engine;
deriving whether a plurality of amplitudes of the first signal at the fundamental frequency and one or more harmonic frequencies exceed an undesired installation threshold value; and
identifying an asymmetric piston as having an undesired installation if the undesired installation threshold value exceeds the plurality of amplitudes of the first signal and the one or more harmonic frequencies.

2. The method of claim 1, comprising performing one or more preventative actions when the plurality of amplitudes exceed the undesired installation threshold value.

3. The method of claim 2, wherein the one or more preventative actions comprise:
sending an alert to a user that the asymmetric piston is installed undesiredly;
placing the engine in a reduced operating state;
shutting down the engine; or
some combination thereof.

4. The method of claim 2, wherein the one or more preventative actions are performed based on a severity of the plurality of amplitudes.

5. The method of claim 1, wherein the fundamental frequency is derived by:
correctly installing the asymmetric piston in a test environment;
running the reciprocating engine; and
determining a first fundamental frequency of the cylinder with a correctly installed asymmetric piston traversing within, a second fundamental frequency of the cylinder with an incorrectly installed asymmetric piston traversing within, or some combination thereof.

6. The method of claim 1, wherein the cylinder comprises a thrust face and an anti-thrust face, and the first knock sensor is disposed on the thrust face and is oriented perpendicular to an axis of piston travel within the cylinder.

7. The method of claim 1, wherein the retrieving, receiving, deriving, and identifying the asymmetric piston are executed during a test mode engine start, and wherein the test mode is terminated upon determination that the asymmetric piston is installed correctly.

8. The method of claim 1, wherein the asymmetric piston comprises:
a skirt having axial profile asymmetry, radial profile asymmetry, or both;
a top land, a second land, a third land, or some combination thereof, having an axis offset, radial profile asymmetry, axial profile asymmetry, or some combination thereof;
a bowl having an asymmetrical shape;
a pin being offset from an axial axis;
a center of gravity being offset from an axial axis;
material selection for portions of the asymmetric piston that cause an asymmetry;
an undercrown having an axial profile asymmetry, radial profile asymmetry, or both; or
some combination thereof.

9. A system, comprising:
an engine control unit (ECU) configured to control operations of an engine, wherein the ECU comprises a processor configured to perform the steps of:
retrieve a fundamental frequency of a cylinder type;
receive a first signal from a first knock sensor disposed on a cylinder, wherein the cylinder is disposed in the engine;
derive whether a plurality of amplitudes of the first signal at the fundamental frequency and one or more harmonic frequencies exceed an undesired installation threshold value; and
identify an asymmetric piston as having an undesired installation if the undesired installation threshold value exceeds the plurality of amplitudes of the first signal and the one or more harmonic frequencies.

10. The system of claim 9, wherein the asymmetric piston comprises:
a skirt having axial profile asymmetry, radial profile asymmetry, or both;
a top land, a second land, a third land, or some combination thereof, having an axis offset, radial profile asymmetry, axial profile asymmetry, or some combination thereof;
a bowl having an asymmetrical shape;
a pin being offset from an axial axis;
a center of gravity being offset from an axial axis;
material selection for portions of the asymmetric piston that cause an asymmetry;
an undercrown having an axial profile asymmetry, radial profile asymmetry, or both; or
some combination thereof.

11. The system of claim 9, wherein the processor is configured to perform the steps as a start-up routine to identify an incorrectly installed asymmetric piston when the engine is first started.

12. The system of claim 9, wherein the first knock sensor is oriented perpendicular to an axis of piston travel within the cylinder.

13. The system of claim 9, wherein the processor is configured to perform one or more preventative actions when the plurality of amplitudes exceed the incorrect installation threshold value.

14. The system of claim 13, wherein the one or more preventative actions comprise:
sending an alert to a user that the asymmetric piston is installed incorrectly;
placing the engine in a reduced operating state;
shutting down the engine; or
some combination thereof.

15. A non-transitory computer readable medium comprising executable instructions that, when executed by a processor, cause the processor to:
retrieve a fundamental frequency of a cylinder type;
receive a first signal from a knock sensor disposed on a cylinder, wherein the cylinder is disposed in an engine;
derive whether a plurality of amplitudes of the first signal at the fundamental frequency and one or more harmonic frequencies exceed an undesired installation threshold value; and
identify an asymmetric piston as having an undesired installation if the undesired installation threshold value exceeds the plurality of amplitudes of the first signal and the one or more harmonic frequencies.

16. The computer readable medium of claim 15, wherein the undesired installation threshold value is a certain percentage of amplitude higher than baseline amplitudes at the fundamental frequency and the one or more harmonic frequencies.

17. The computer readable medium of claim 15, wherein the executable-instructions, when executed by the processor, cause the processor to perform one or more preventative actions when the plurality of amplitudes exceed the undesired installation threshold value, wherein the one or more preventative actions comprise:
sending an alert to a user that the asymmetric piston is installed incorrectly;
placing the engine in a reduced operating state;
shutting down the engine; or
some combination thereof.

18. The computer readable medium of claim 15, wherein the executable-instructions are executed by the processor as a start-up routine when the engine is first started.

19. The computer readable medium of claim 15, wherein the undesired installation threshold value is based at least in part on in situ training of all cylinders included in the engine.

20. The computer readable medium of claim 15, wherein the one or more harmonic frequencies are integer multiples of the fundamental frequency.
